(19) United States
(12) Patent Application Publication
(10) Pub. No.: US 2024/0001899 A1
(43) Pub. Date: Jan. 4, 2024

(54) METHOD FOR CONTROLLING A BRAKE SYSTEM AND BRAKE SYSTEM FOR MOTOR VEHICLES

(71) Applicant: Continental Automotive Technologies GmbH, Hannover (DE)

(72) Inventor: Aleksandar Stanojkovski, Kleinostheim (DE)

(73) Assignee: Continental Automotive Technologies GmbH, Hannover (DE)

(21) Appl. No.: 18/254,855

(22) PCT Filed: Oct. 21, 2021
(86) PCT No.: PCT/DE2021/200158

§ 371 Date: May 27, 2023

(30) Foreign Application Priority Data
Nov. 27, 2020 (DE) 10 2020 214 972.0

(51) Int. Cl. B60T 13/66; B60T 13/74; B60T 7/04

(52) U.S. Cl. CPC B60T 13/662; B60T 13/745; B60T 7/042; B60T 2270/82

(57) ABSTRACT

A method for controlling a brake system comprises a linear actuator and a hydraulic pump. For a rapid pressure build-up, the linear actuator and the hydraulic pump are switched into synchronous operation at a rate of change of the braking request signal greater than a threshold value. The embodiments also relates to a brake system for motor vehicles.

### TECHNICAL FIELD

The embodiments relate to a method for controlling a brake system having a linear actuator and a hydraulic pump.

### BACKGROUND

Most modern brake systems nowadays work according to the brake-by-wire method. That is to say that the driver no longer has a direct mechanical connection to the individual wheel brakes via the brake pedal in a normal operating mode. Instead, a driver braking request is detected by means of a sensor system and a generally electrical pressure application device is activated to build up a brake pressure in the wheel brakes in accordance with the driver braking request. The pressure application devices used in this case must satisfy a large number of requirements in this case. Up to now in this case, it has not been possible at acceptable costs to provide a brake system which can build up a brake pressure as quickly as a conventional brake system with a direct mechanical connection between the driver and the wheel brake when the braking demand increases very rapidly. Since at high speeds even slight delays in pressure build-up lead to a considerable lengthening of the braking distance, vehicles with such brake systems have disadvantages in terms of braking distance compared to those with conventional brake systems.

### SUMMARY

It is therefore an object of the embodiments to provide a method for controlling such a brake system which avoids these delays.

A braking request signal is monitored and, if a rate of change of the braking request signal is greater than a threshold value, the linear actuator and the hydraulic pump are switched into synchronous operation. In synchronous operation, the linear actuator and the hydraulic pump are operated simultaneously to convey hydraulic volume into at least one wheel brake in order to build up a brake pressure in the wheel brake. Thus, the linear actuator and the hydraulic pump deliver simultaneously into a common wheel brake. With the method, the system determines directly from the braking request signal whether there is a need for both pressure sources in order to implement the request. Thus, a requested brake pressure can be achieved quickly, thereby enabling the braking distance of the motor vehicle to be reduced in an efficient way.

In an embodiment, the braking request signal is generated by a brake sensor or a driving assistance system. A brake pedal travel sensor and/or a pressure sensor are suitable as the brake sensor. In this case, a master cylinder pressure or the system pressure can be measured and used directly. Alternatively, the brake pedal is of dry design, i.e. there is no connection to the hydraulics. In this case, a corresponding brake pedal sensor can be used. Possible driving assistance systems are, for example, an automatic headway control system and/or an emergency braking assistant, which generate a braking request signal directly and independently of the driver.

In a further embodiment, the hydraulic pump and the linear actuator are connected in series, for example by opening a hydraulic valve between a suction side of the hydraulic pump and an outlet of the linear actuator. Here, a hydraulic pressure generated by the linear actuator is further intensified by the hydraulic pump, ensuring that a higher brake pressure is achieved more quickly in the wheel brakes.

In a further embodiment, the hydraulic pump and the linear actuator are connected in parallel, wherein the suction side of the hydraulic pump is connected to a hydraulic reservoir. Thus, the hydraulic pump and the linear actuator convey volume into the wheel brake substantially independently of one another. The volumes of the hydraulic pump and the linear actuator add up here to a total volume which is conveyed into the wheel brake. Thus, the volume required in the wheel brake is achieved quickly. It is also possible to switch between the two modes. Thus, a large volume is required at the beginning of braking since the piston of the wheel brake still has far to travel and the two pressure application devices can be connected in parallel therewith. As soon as contact is made between the brake pad and the brake disk, a large hydraulic volume is no longer required. The two pressure application devices can then be connected in series.

In a further embodiment, the linear actuator is controlled by a first control unit, and the hydraulic pump is controlled by a second control unit. In this case, the first control unit and the second control unit communicate with one another via a communication interface. This offers additional redundancy since, in the event of failure of one of the control units, at least one of the pressure application devices still remains functional in order to brake the vehicle to a halt.

In a another embodiment, the first control unit evaluates the braking request signal and sends a command for activating the hydraulic pump to the second control unit if a detected rate of change of the braking request signal is greater than the threshold value. It is therefore not necessary to provide an additional connection between the hydraulic pump and the first control unit since the control logic remains with the second control unit.

In a further embodiment, the brake sensor is a hydraulic pressure sensor which is read out by the second control unit. This can be a system pressure sensor or a wheel brake pressure sensor. Thus, the second control unit, which is responsible for controlling the hydraulic pump, can automatically detect whether the hydraulic pump is required.

In a embodiment, the second control unit evaluates the braking request signal in order to activate the hydraulic pump if a detected rate of change of the braking request signal is greater than the threshold value.

In a embodiment, the second control unit evaluates a first braking request signal. This can be, for example, the signal of a sensor which is monitored directly by the second control unit. If a detected rate of change of the first braking request signal is greater than a first threshold value, the second control unit activates the hydraulic pump with a first power. At the same time, the first control unit evaluates a second braking request signal and, if a detected rate of change of the second braking request signal is greater than a second threshold value, sends a command for activating the hydraulic pump to the second control unit. For example, this can be the signal of a sensor which is connected directly to the first control unit. When the command is received, the second control unit then regulates the hydraulic pump to a second power, which is greater than the first power. Thus, the pump is activated directly without delay, but is only set to the full required power when the actual command is received from the first control unit.

In a embodiment, a transition from synchronous operation as described above to individual operation of the hydraulic pump takes place when the linear actuator reaches its knee point, an ABS control operation is triggered or a predetermined locking pressure is reached. The knee point of the linear actuator is reached when the piston of the linear actuator has moved all the way forward and therefore has to move back again for further volume delivery, drawing in brake fluid from a brake fluid reservoir as it does so. As soon as locking of the wheels or of at least one wheel is detected, it is likewise possible to switch over to individual operation of the hydraulic pump since the pressure across the hydraulic pump can be set precisely with an associated overflow valve. In a control system, a predetermined pressure value, the locking pressure, is stored in the brake system of the vehicle. As soon as the system pressure reaches this pressure, switching to individual operation of the hydraulic pump is likewise performed.

In a further embodiment, a hydraulic valve is arranged in parallel with the hydraulic pump and in series between the linear actuator and a wheel brake, and the hydraulic valve is opened or closed in synchronous operation. If the valve is opened, the linear actuator can convey volume into the wheel brake through this valve, on the one hand, and through the hydraulic pump, on the other hand.

In a further embodiment, the brake system comprises two subcircuits, wherein two wheel brakes and a hydraulic pump are assigned to each subcircuit and, in synchronous operation, both pumps are activated and the linear actuator is connected to only one subcircuit or both subcircuits.

The object is furthermore achieved by a brake system for motor vehicles having a linear actuator and a hydraulic pump, wherein the brake system is designed to carry out a method described above.

### BRIEF DESCRIPTION OF THE DRAWINGS

Further features, advantages and possible applications of the embodiments also result from the description below of exemplary embodiments and the drawings. All of the features described and/or pictorially depicted belong to the subject matter of the invention both individually and in any combination, also independently of their summarization in the claims or the back-references thereof.

FIG. 1 schematically shows a brake system according to the invention in a first embodiment, and

FIG. 2 schematically shows a brake system according to the invention in a second embodiment.

### DETAILED DESCRIPTION

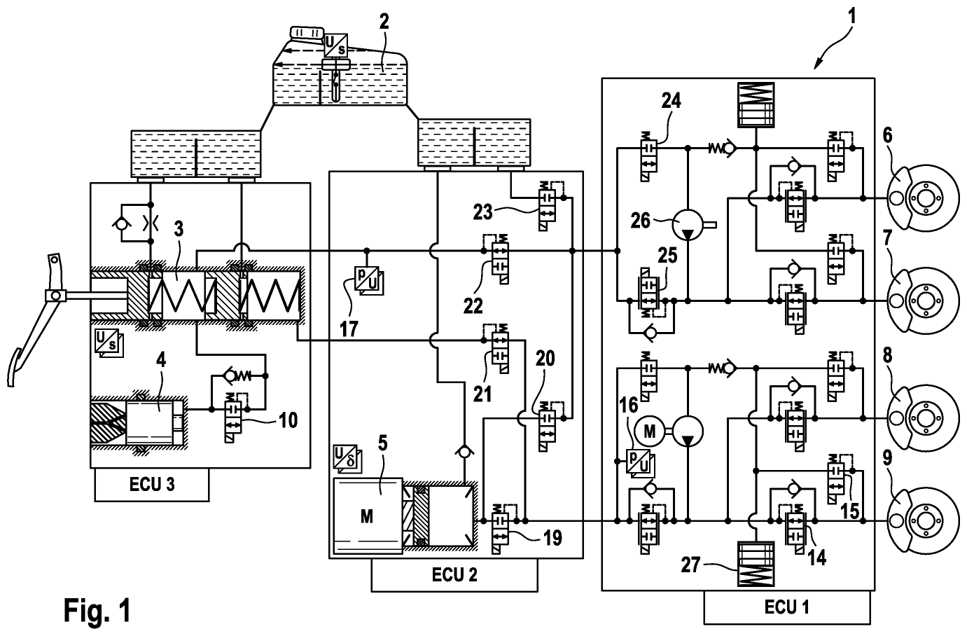

FIG. 1 illustrates a hydraulic brake system 1 by means of which the method can be carried out. The brake system 1 is equipped with extended redundancy of the kind required for autonomous driving, this being achieved, for example, by two independent pressure application devices. In a normal operating mode, the brake system 1 operates according to the brake-by-wire method. In this case, a braking force is exerted by the driver on a brake master cylinder 3, which is designed as a tandem brake master cylinder 3 with two chambers. As a result, hydraulic volume is displaced via an open simulator valve 10 into a simulator 4, by means of which a pedal feel is generated. In the embodiment shown, only one chamber of the tandem brake master cylinder 3 is connected to the simulator 4, while the second chamber merely exerts pressure against a closed first shut-off valve 21. The first shut-off valve 21 separates and connects the tandem brake master cylinder 3 from and to a first subcircuit of the brake system 1, which comprises the wheel brakes 7, 8 of the rear left and front right wheels with the respective inlet valves 14 and the respective outlet valves 15. A second shut-off valve 22 connects the tandem brake master cylinder 3 to the second subcircuit of the brake system 1. The second subcircuit of the brake system 1 comprises the wheel brakes 6, 9 of the rear right and front left wheels with the respective inlet valves 14 and outlet valves 15. The second shut-off valve 22 is also closed in the normal operating mode. In the embodiment shown, the first and second subcircuits are of substantially symmetrical construction. Different splitting of the wheel brakes 6, 7, 8, 9 between the first and second subcircuits, for example with both front wheel brakes in the first subcircuit and the rear wheel brakes in the second subcircuit, is also possible.

Also provided in the brake system 1 is a linear actuator 5, which is connected via a first supply valve 19 to the first subcircuit and is connected via a second supply valve 20 to the second subcircuit. The first supply valve 19 connects and separates the first subcircuit to and from the linear actuator 5 and the second supply valve 20 connects and separates the second subcircuit to and from the linear actuator 5. By virtue of the symmetrical construction, the second subcircuit can also be regarded as the first subcircuit, and the first subcircuit can also be regarded as the second subcircuit for the purposes of the embodiments. In a normal operating mode, the first supply valve 19 and the second supply valve 20 are open, and therefore the linear actuator 5 can convey brake fluid into all the wheel brakes 6, 7, 8, 9. The brake fluid here flows out of the linear actuator 5, through an open switchover valve 25 of the respective subcircuit and through the inlet valve 14 of the respective wheel brakes 6, 7, 8, 9 into the wheel brake 6, 7, 8, 9. The pump isolating valves 24 of the two subcircuits are closed in the normal operating mode. The braking force is thus generated by the linear actuator 5.

In order to reduce the pressure of the wheel brakes 6, 7, 8, 9, for example in the case of ABS control, the outlet valves 15 of the individual wheel brakes 6, 7, 8, 9 can be opened. The brake fluid then flows through the respective outlet valve into a low-pressure accumulator 27 of the respective subcircuit.

Each of the two subcircuits has a hydraulic pump 26, which is connected in each case to a switchover valve 25, a pump isolating valve 24 and a low-pressure accumulator 27. In a fallback level, for example in the event of a defect of the linear actuator, the shut-off valves 21, 22 are opened, the switchover valves 25 are closed and the pump isolating valves 24 are opened. When the brake pedal is actuated, the hydraulic pumps 26 are activated, with the result that said pumps pump brake fluid into the wheel brakes 6, 7, 8, 9. The hydraulic pumps 26 thus intensify the brake pressure exerted by the driver via the tandem brake master cylinder 3.

The first subcircuit and the second subcircuit are thus constructed substantially in parallel. The system pressure in the first subcircuit can be determined by a pressure measuring device 16, which is referred to as a system pressure sensor 16. Furthermore, a further pressure measuring device 17 is arranged on the tandem brake master cylinder 3 in order to determine the brake pressure exerted by the driver, this sensor being referred to as the master cylinder pressure sensor 17. A connection of the second subcircuit to the reservoir 2 can be established by means of a feeder valve 23. This valve can be opened, in particular, if the brake fluid volume in the brake circuit is to be reduced or increased.

In normal operation, the pedal travel sensor and the master cylinder pressure sensor 17 are monitored by a control unit and a braking request signal is generated on the basis of the sensor signals thereof. The control unit then controls the linear actuator 5 on the basis of the braking request signal to generate a braking pressure.

If it is now determined that the rate of change, that is to say the time derivative, of the braking request signal exceeds a threshold value, synchronous operation is started, in which both the linear actuator 5 and the hydraulic pump 26 are operated in order to jointly convey brake fluid into at least one wheel brake 6, 7, 8, 9. The brake system continues to be operated here in the brake-by-wire mode, that is to say the shut-off valves 21, 22 remain closed and brake fluid continues to be displaced only into the simulator 4 by the brake master cylinder 3. The switchover valves 25 are closed and the pump isolating valves 24 are opened, with the result that the hydraulic pumps 26 are connected in series downstream of the linear actuator. A hydraulic pressure built up by the linear actuator is thus further intensified by the hydraulic pumps 26. A large brake pressure is thus rapidly applied to the wheel brakes 6, 7, 8, 9. Thus, a required braking force can be quickly built up in the event of a fast pedal depression, and the braking distance can thus be decisively shortened.

Alternatively, the hydraulic pump can be connected in parallel with the linear actuator. For this purpose, the switchover valve 25 is opened and the pump isolating valve 24 is closed. The hydraulic pump 26 then draws in fluid from the low-pressure accumulator 27 and pumps this volume to the respective wheel brakes 6, 7, 8, 9, while the linear actuator simultaneously conveys volume through the open switchover valve into the wheel brakes 6, 7, 8, 9.

The linear actuator 5 is controlled here by a control unit ECU2 and the hydraulic pump 26 is controlled by a control unit ECU 1. The control unit ECU 1 also receives data from a system pressure sensor 16, which is connected directly to this control unit ECU 1. In this case, it is envisaged that the control unit ECU 1 monitors the system pressure by means of the system pressure sensor 16 and, if a rate of change is greater than an associated system pressure change threshold value, opens the pump isolating valve and activates the hydraulic pump 26 with a first power or duty cycle. At the same time, the control unit ECU2 monitors a master cylinder pressure by means of the master cylinder pressure sensor 17 and, if a rate of change greater than an associated master cylinder pressure change threshold value is detected, sends a pump activation signal to the control unit ECU 1 via a CAN interface. As soon as the control unit ECU 1 receives the pump activation signal, it switches the hydraulic pump 26 to a second, higher pump power or duty cycle. It is thus possible to regulate the actual control of synchronous operation at the control unit ECU 2 but to bridge the signal transit times by means of advance control of the hydraulic pump 26 by the control unit ECU 1.

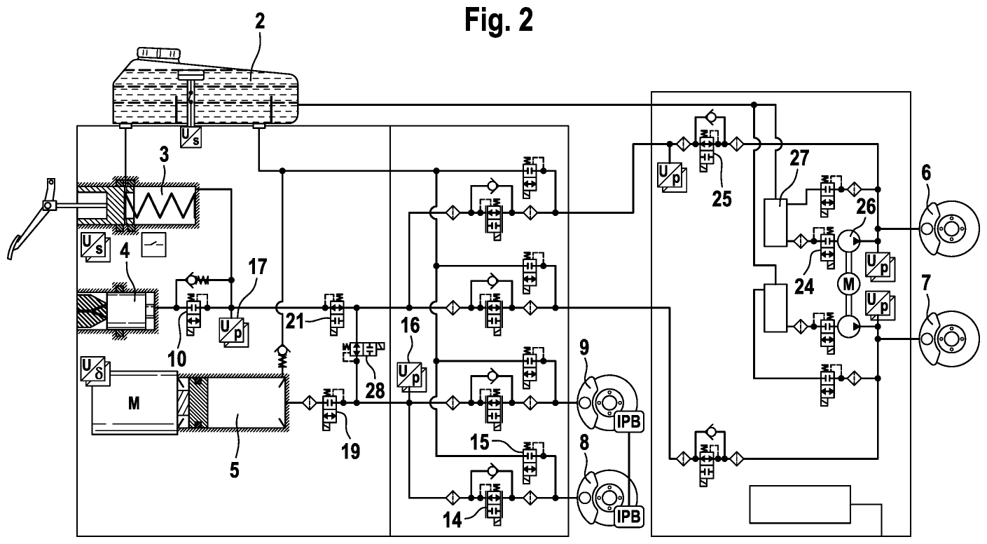

A second embodiment of a brake system is now illustrated in FIG. 2. The brake system of FIG. 2 has a brake master cylinder 3 which is embodied only with a single chamber. In normal operation, this is connected to the simulator 4 via an open simulator valve 10. A shut-off valve 21 is closed in normal operation, and therefore the brake master cylinder has no open flow connection to the wheel brakes 6, 7, 8, 9. The linear actuator 5 is connected to the wheel brakes 8, 9 via a supply valve 19 which is open during normal operation and via inlet valves 14, which are likewise open. Furthermore, the linear actuator 5 has a connection via a circuit isolating valve 28 and via corresponding inlet valves 14 to the wheel brakes 6, 7 of the front axle. The connection is passed through a further brake unit with a switchover valve 25, which is open in normal operation. For reasons of redundancy, the further brake unit comprises a further pressure application device, which is embodied as a hydraulic pump 26. The hydraulic pump 26 is connected on the suction side, via a normally closed pump isolating valve 24, to a low-pressure accumulator 27, which in turn has a connection to the brake fluid reservoir 2. The low-pressure accumulator 27 is furthermore connected to the wheel brake 6, 7 by a further valve.

In this embodiment, the linear actuator 5 and the hydraulic pump 26 are connected in parallel and operated simultaneously in synchronous operation. For this purpose, the switchover valve 25 remains open, with the result that the linear actuator 5 has an open flow connection into the wheel brakes 6, 7. Furthermore, the pump isolating valve 24 is opened, with the result that the hydraulic pump 26 can draw brake fluid from the low-pressure accumulator 27 and through it from the brake fluid reservoir 2. Thus, the linear actuator 5 and the hydraulic pump each convey their own volume, adding up to a total volume conveyed into the wheel brakes 6, 7.

The control of the hydraulic pump 26 and the linear actuator 5 can be performed by two separate control units, as described above in relation to the first embodiment.

1. A method for controlling a brake system having a linear actuator and a hydraulic pump comprising:
monitoring a braking request signal
switching the linear actuator and the hydraulic pump into synchronous operation when a rate of change of the braking request signal is greater than a threshold value, wherein, in synchronous operation, the linear actuator and the hydraulic pump are operated simultaneously to convey hydraulic volume into at least one wheel brake in order to build up a brake pressure in the wheel brake.

2. The method as claimed in claim 1, further comprising generating the braking request signal with one of a brake sensor and a driving assistance system.

3. The method as claimed in claim 1, wherein the hydraulic pump and the linear actuator are connected in series, by opening a hydraulic valve between a suction side of the hydraulic pump and an outlet of the linear actuator.

4. The method as claimed in claim 1, wherein the hydraulic pump and the linear actuator are connected in parallel, wherein the suction side of the hydraulic pump is connected to a hydraulic reservoir.

5. The method as claimed in claim 1, further comprising controlling the linear actuator with a first control unit and the hydraulic pump with a second control unit, wherein the first control unit and the second control unit communicate with one another via a communication interface.

6. The method as claimed in claim 5, further comprising evaluating the braking request signal with the first control unit and sending a command for activating the hydraulic pump to the second control unit when a detected rate of change of the braking request signal is greater than the threshold value.

7. The method as claimed in claim 2, wherein the brake sensor is a hydraulic pressure sensor which is read out by the second control unit.

8. The method as claimed in claim 5, further comprising evaluating the braking request signal with the second control unit and activating the hydraulic pump when a detected rate of change of the braking request signal is greater than the threshold value.

9. The method as claimed in claim 5, further comprising:
evaluating a first braking request signal with the second control unit and activating the hydraulic pump with a first power when a detected rate of change of the first braking request signal is greater than a first threshold value;
evaluating a second braking request signal with the first control unit and sending the command for activating the hydraulic pump to the second control unit when a detected rate of change of the second braking request signal is greater than a second threshold value; and
activating the hydraulic pump with the second control unit with a second power, greater than the first power, when the command is received.

10. The method as claimed in claim 1, wherein carrying out a transition from synchronous operation to individual operation of the hydraulic pump when one of: the linear actuator reaches its knee point, an ABS control operation is triggered and a predetermined locking pressure is reached.

11. The method as claimed in claim 1, wherein a hydraulic valve is arranged in parallel with the hydraulic pump and in series between the linear actuator and a wheel brake, and the hydraulic valve is open or closed in synchronous operation.

12. The method as claimed in claim 1, wherein the brake system comprises two subcircuits, wherein two wheel brakes and a hydraulic pump are assigned to each subcircuit and, in synchronous operation, both pumps are activated and the linear actuator is connected to only one subcircuit or both subcircuits.

13. A brake system for motor vehicles comprising:
at least one wheel brake;
a linear actuator; and
a hydraulic pump, wherein the linear actuator and the hydraulic pump are switched into synchronous operation when a rate of change of a braking request signal is greater than a threshold value, wherein, in synchronous operation, the linear actuator and the hydraulic pump are operated simultaneously to convey hydraulic volume into at least one wheel brake in order to build up a brake pressure in the wheel brake.

14. The brake system as claimed in claim 13, wherein the braking request signal is generated by one of a brake sensor and a driving assistance system.

15. The brake system as claimed in claim 13, wherein the hydraulic pump and the linear actuator are connected in series by opening a hydraulic valve between a suction side of the hydraulic pump and an outlet of the linear actuator.

16. The brake system as claimed in claim 13, wherein the hydraulic pump and the linear actuator are connected in parallel, wherein the suction side of the hydraulic pump is connected to a hydraulic reservoir.

17. The brake system as claimed in claim 13, wherein the linear actuator is controlled by a first control unit and the hydraulic pump is controlled by a second control unit, wherein the first control unit and the second control unit communicate with one another via a communication interface.

18. The brake system as claimed in claim 17, wherein the first control unit evaluates the braking request signal and sends a command for activating the hydraulic pump to the second control unit if a detected rate of change of the braking request signal is greater than the threshold value.

19. The brake system as claimed in claim 17, wherein the brake sensor is a hydraulic pressure sensor which is read out by the second control unit.

20. The brake system as claimed in claim 17, wherein the second control unit evaluates the braking request signal and activates the hydraulic pump if a detected rate of change of the braking request signal is greater than the threshold value.
